(19) United States
(12) Patent Application Publication
(10) Pub. No.: US 2012/0026130 A1
(43) Pub. Date: Feb. 2, 2012

(54) LINEARITY IMPROVEMENT OF A CAPACITIVE TOUCH PAD

(75) Inventors: KUO-TAI WANG, NEW TAIPEI CITY (TW); CHENG-HUI LIN, PINGTUNG COUNTY (TW); HSIN-FU HSU, TAINAN CITY (TW); KUO-MING HUANG, NEW TAIPEI CITY (TW)

(73) Assignee: ELAN MICROELECTRONICS CORPORATION, HSINCHU (TW)

(21) Appl. No.: 13/188,842

(22) Filed: Jul. 22, 2011

(30) Foreign Application Priority Data
Jul. 29, 2010 (TW) 099125128

(51) Int. Cl. G06F 3/045

(52) U.S. Cl. 345/174

(57) ABSTRACT

A capacitive touchpad includes a first trace established by a string of first rhombic sensing cells successively in a first direction and a plurality of singular second rhombic sensing cells branched in a second direction from the string of first rhombic sensing cells, and a second trace established by a string of third rhombic sensing cells successively in the first direction and a plurality of singular fourth rhombic sensing cells branched in the second direction from the string of third rhombic sensing cells, and the second rhombic sensing cells are interleaved with the fourth rhombic sensing cells in the first direction. The capacitive touchpad is thus improved in its linearity.

### FIELD OF THE INVENTION

The present invention is related generally to a capacitive touchpad and, more particularly, to the linearity improvement of a capacitive touchpad.

### DESCRIPTION OF RELATED ART

The existing approach for linear calculation of movement of a conductor on a capacitive touchpad considers relative area where the conductor contacts the capacitive touchpad, and thus different sensing cells in size will lead to different result of linear calculation due to the different area ratio between the conductor and the sensing cells. For example, as shown in FIG. 1, a same conductor 10 touching at a same relative position on two capacitive touchpads 12 and 14 that are different in size will cause the capacitive touchpads 12 and 14 to give different coordinates to the conductor 10 because the conductor 10 has a different area ratio to the sensing cells of the capacitive touchpads 12 and 14, respectively. For an object moving on a capacitive touchpad from any position, the larger a sensing cell is, the greater the resultant linearity error is.

To improve the linearity of large size capacitive touchpads, U.S. Pat. No. 6,147,680 proposes interleaved traces as depicted in FIG. 2, in which the extensions of the traces are actually interleaved so that they overlap with portions of the adjacent trace. However, in this trace layout, there will be two crossover intersections between any of X-directional traces and any of Y-directional trace, for example, as indicated by the circled areas in FIG. 2, the intersections 18 and 20 between the traces X1 and Y2. More area of crossover intersections will bring greater mutual capacitance between the X-directional and Y-directional traces, which makes the trace layout not applicable to a two-layer circuit board design, but necessary to be implemented by a four-layer circuit board design for preventing mutual capacitance. As a result, in addition to increased manufacturing costs, special consideration has to be paid in software design for eliminating mutual capacitance.

Therefore, it is desired a trace layout of a capacitive touchpad to improve the linearity of the capacitive touchpad.

### SUMMARY OF THE INVENTION

An objective of the present invention is to provide a linearity improved capacitive touchpad.

Another objective of the present invention is to provide a mutual capacitance reduced capacitive touchpad.

According to the present invention, a capacitive touchpad includes two interleaved traces, the first one including a string of first rhombic sensing cells successively in a first direction and a plurality of singular second rhombic sensing cells in a second direction, and the second one including a string of third rhombic sensing cells successively in the first direction and a plurality of singular fourth rhombic sensing cells in the second direction, and the second rhombic sensing cells are interleaved with the fourth rhombic sensing cells in the first direction.

According to the present invention, a capacitive touchpad includes two interleaved traces, the first one including a string of first rhombic sensing cells successively in a first direction and a plurality of strings of second rhombic sensing cells in a second direction, and the second one including a string of third rhombic sensing cells successively in the first direction and a plurality of strings of fourth rhombic sensing cells in the second direction, and the plurality of strings of second rhombic sensing cells are interleaved with the plurality of strings of fourth rhombic sensing cells in the first direction.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a diagram showing the linearity error of two capacitive touchpads having a same trace layout but being different in size;

FIG. 2 is a diagram showing a conventional interleaved trace layout for linearity improvement of a capacitive touchpad;

FIG. 3 is a perspective diagram of a first embodiment according to the present invention for linearity improvement of a capacitive touchpad;

FIG. 4 is a perspective diagram of a second embodiment according to the present invention for linearity improvement of a capacitive touchpad;

FIG. 5 is a perspective diagram of a third embodiment according to the present invention for linearity improvement of a capacitive touchpad;

FIG. 6 shows a track identified by the capacitive touchpad of FIG. 1 when an object moves thereon; and

FIG. 7 shows a track identified by the capacitive touchpad of FIG. 4 when an object moves thereon.

### DETAILED DESCRIPTION OF THE INVENTION

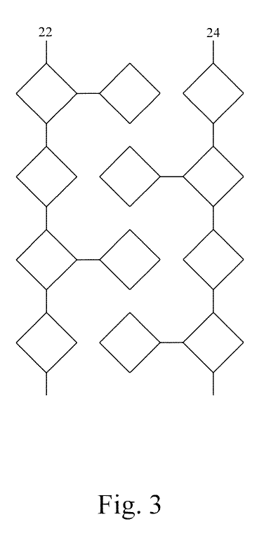

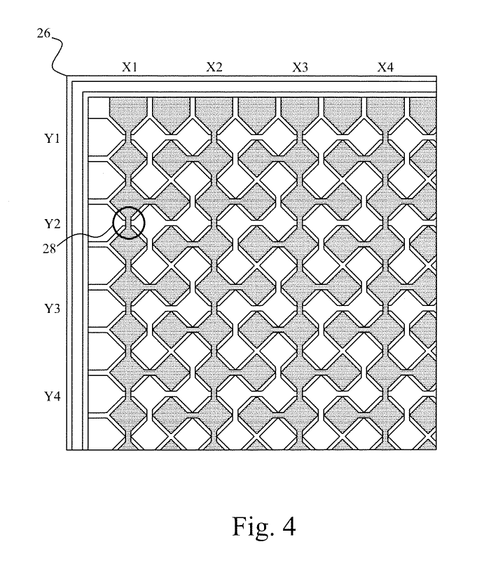

FIG. 3 is a perspective diagram of a first embodiment according to the present invention for linearity improvement of a capacitive touchpad, which combines interleaved traces with rhombic sensing cells that have the advantage of uniform layout, to add sensing cells on each trace but not increasing the number of traces, and thus allows production of a capacitive touchpad in a size up to two times as large as that made conventionally, while improving linearity of the capacitive touchpad. As shown in FIG. 3, each of X-directional traces 22 and 24 includes a string of rhombic sensing cells successively in X-direction, and a plurality of singular rhombic sensing cells branched in Y-direction therefrom. It is noted that rather than connecting a same rhombic sensing cell in Y-direction, the traces 22 and 24 alternately and independently connect rhombic sensing cells in Y-direction, and thus the traces 22 and 24 have their branched rhombic sensing cells interleaved with each other in X-direction. When an object moves from any position on the capacitive touchpad, linearity error can be reduced. The layout of rhombic sensing cells according to the present invention is advantaged by not only that the sensing cells in both directions are evenly distributed over the capacitive touchpad, but also that the area of crossover intersections between the traces is reduced, thereby improving mutual capacitance. For example, as shown in FIG. 4, in a capacitive touchpad 26 having the structure of FIG. 3 applied to both X-directional and Y-directional traces, any of the X-directional traces and any of the Y-directional traces are singularly crossover intersected with each other. Namely, there is only a crossover intersection between each X-directional trace and each Y-directional trace, for example, as indicated by the circled area in FIG. 4, the crossover intersection 28 between the traces X1 and Y2. The singular crossover intersection can unburden the complexity of software design and allow linear calculation and performance more manageable. As the area of crossover intersections is reduced to half, the trace layout is applicable to a two-layer circuit board design for a capacitive touchpad.

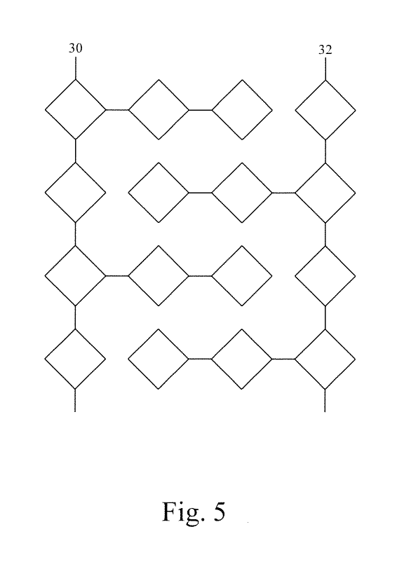

FIG. 5 is another embodiment according to the present invention, in which traces 30 and 32 are similar to the traces 22 and 24 of FIG. 3, respectively, but each of the branched rhombic sensing cells in Y-direction is increased to two, in the same interleaving scheme in X-direction. This trace layout is suitable for larger size capacitive touchpads, without the need of increasing traces while improving the capacitive touchpad in linearity. In other embodiments, for realizing an even larger capacitive touchpad, each string of rhombic sensing cells in Y-direction branched from the string of rhombic sensing cells in X-direction includes more rhombic sensing cells, to minimize the number of traces and improve the linearity of the even larger capacitive touchpad. Furthermore, a trace layout according to the present invention may be applied to the traces of only one of the directions to improve the linearity in this direction, while the traces in the other direction remain connecting the rhombic sensing cells as lines without branched rhombic sensing cells.

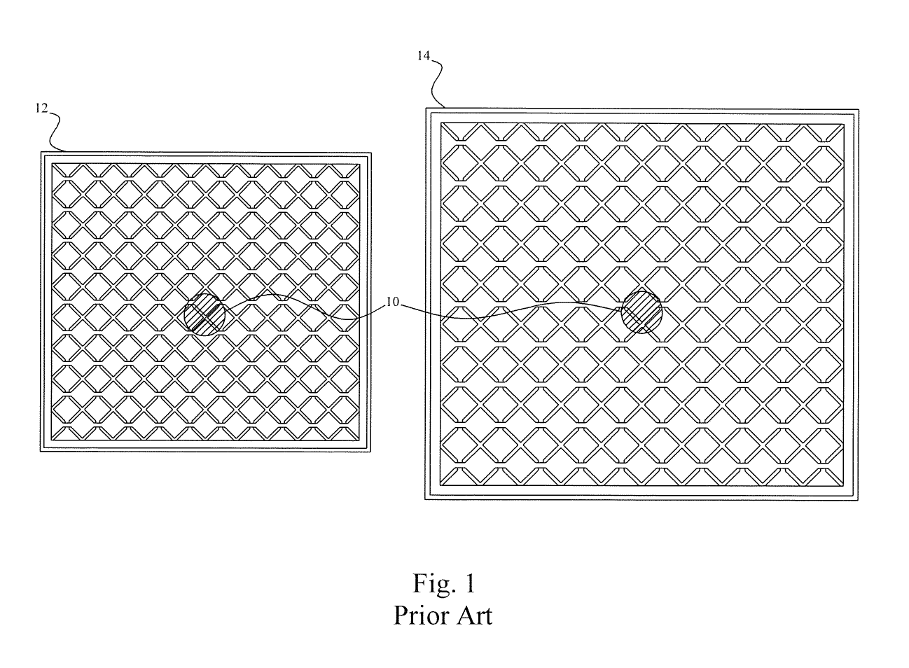

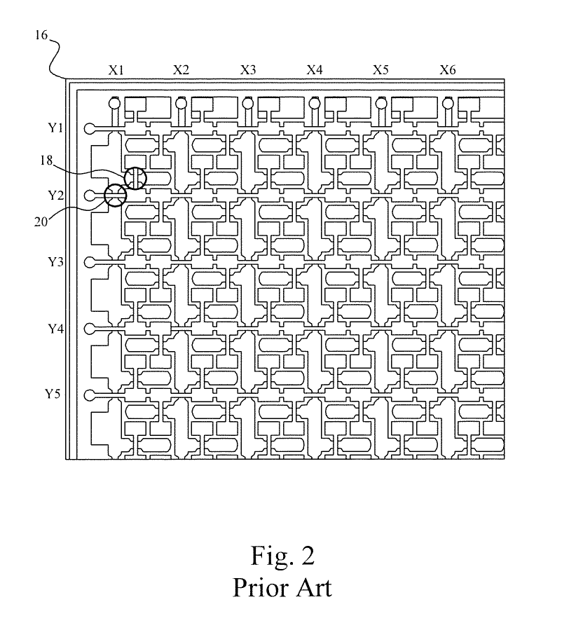

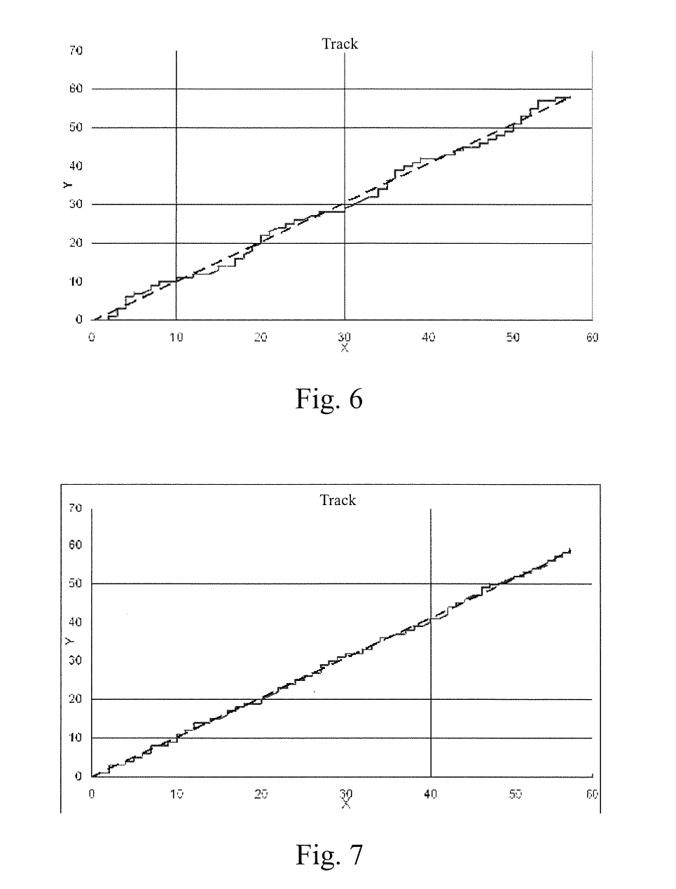

For comparison of the effect on linearity improvement, FIGS. 6 and 7 show tracks identified by the capacitive touchpads of FIGS. 1 and 4, respectively, when an object moves thereon. When a conductor moves in a skewed line, the expected route is as the broken lines shown in FIGS. 6 and 7. However, in an experiment conducted in the conventional capacitive touchpad of FIG. 1, the actual result is wavelike, as the track shown in FIG. 6, with the deviation increased with the increased distance between the sensing cells in the capacitive touchpad. On the other hand, in an experiment conducted in the capacitive touchpad of FIG. 4, the actually detected track of the object is as shown in FIG. 7, being more close to the expected route and demonstrating the improvement in linearity.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A capacitive touchpad comprising:
a first trace established by a string of first rhombic sensing cells successively in a first direction and a plurality of singular second rhombic sensing cells branched in a second direction from the string of first rhombic sensing cells; and
a second trace established by a string of third rhombic sensing cells successively in the first direction and a plurality of singular fourth rhombic sensing cells branched in the second direction from the string of third rhombic sensing cells;
wherein the second rhombic sensing cells are interleaved with the fourth rhombic sensing cells in the first direction.

2. The capacitive touchpad of claim 1, wherein the first and second directions are perpendicular to each other.

3. The capacitive touchpad of claim 1, further comprising a third trace established by a string of fifth rhombic sensing cells successively in the second direction.

4. The capacitive touchpad of claim 3, wherein each of the first and second traces is singularly crossover intersected with the third trace.

5. The capacitive touchpad of claim 1, further comprising:
a third trace established by a string of fifth rhombic sensing cells successively in the second direction and a plurality of singular sixth rhombic sensing cells branched in the first direction from the string of fifth rhombic sensing cells; and
a fourth trace established by a string of seventh rhombic sensing cells successively in the second direction and a plurality of singular eighth rhombic sensing cells branched in the first direction from the string of seventh rhombic sensing cells;
wherein the sixth rhombic sensing cells are interleaved with the eighth rhombic sensing cells in the second direction.

6. The capacitive touchpad of claim 5, wherein each of the first and second traces is singularly crossover intersected with the third trace.

7. A capacitive touchpad comprising:
a first trace established by a string of first rhombic sensing cells successively in a first direction and a plurality of strings of second rhombic sensing cells branched in a second direction from the string of first rhombic sensing cells; and
a second trace established by a string of third rhombic sensing cells successively in the first direction and a plurality of strings of fourth rhombic sensing cells branched in the second direction from the string of third rhombic sensing cells;
wherein the plurality of strings of second rhombic sensing cells are interleaved with the plurality of strings of fourth rhombic sensing cells in the first direction.

8. The capacitive touchpad of claim 7, wherein the first and second directions are perpendicular to each other.

9. The capacitive touchpad of claim 7, further comprising a third trace established by a string of fifth rhombic sensing cells successively in the second direction.

10. The capacitive touchpad of claim 9, wherein each of the first and second traces is singularly crossover intersected with the third trace.
